(19) United States
(12) Patent Application Publication
(10) Pub. No.: US 2011/0089167 A1
(43) Pub. Date: Apr. 21, 2011

(54) Arrangement Structure of Guide Chip for High-Frequency Induction Heating Coil

(76) Inventor: Seiichi Sawatsubashi, Tokyo (JP)

(21) Appl. No.: 12/995,205

(22) PCT Filed: Jul. 17, 2008
(86) PCT No.: PCT/JP2008/062892

§ 371 Date: Nov. 30, 2010

(51) Int. Cl. H05B 6/10

(52) U.S. Cl. 219/672

(57) ABSTRACT

To provide an arrangement structure of guide chips for high frequency induction heating coil, which structure is capable of correctly positioning the center of a journal portion or a pin portion of a crankshaft, and thereby capable of uniformly applying high frequency induction heating to the journal portion or the pin portion so as to make a hardened case uniform, and which structure is capable of performing the high frequency induction heating and hardening comparatively simply and inexpensively. An upper side guide chip 21a for high frequency induction heating coil is attached to a side plate 7 in a fixed state, and at least one of left and right side guide chips 21b and 21c for high frequency induction heating coil is arranged in the side plate 7 so as to be movable along the radial direction of a journal portion 2 or a pin portion 4. The dimension between the distal end portions of the left and right side guide chips 21b and 21c for high frequency induction heating coil is set to become smaller than the outside diameter dimension of the journal portion 2 or the pin portion 4 in a free state in which the three guide chips 21a, 21b and 21c for high frequency induction heating coil are not brought into contact with the journal portion 2 or the pin portion 4.

### TECHNICAL FIELD

The present invention relates to an arrangement structure for three upper and left and right side guide chips for a high frequency induction heating coil, which are respectively arranged in contact with an upper side portion and left and right side portions of a journal portion or a pin portion of a crankshaft in order to secure a predetermined gap between the journal portion or the pin portion and a semi-open saddle type high frequency induction heating coil at the time when the journal portion or the pin portion is subjected to high frequency induction heating by the semi-open saddle type high frequency induction heating coil.

### BACKGROUND ART

As shown in FIG. 8, a crankshaft 1, which is an object to be heated, is configured by a journal portion 2 serving as a central shaft, counterweight portions 3 arranged between the mutually adjacent journal portions 2, a pin portion 4 provided between the counterweight portions 3 facing each other, and the like. The journal portion 2 and the pin portion 4 are subjected to high frequency induction heating so as to be hardened. As the hardening method, there are flat hardening and filet R hardening, and the like, In any of the methods, a quench hardened layer needs to be correctly formed in the journal portion 2 or the pin portion 4. Note that as a high frequency induction heating apparatus for applying high frequency induction heating to the journal portion 2 or the pin portion 4, there is adopted. for example, an apparatus as shown in FIG. 1 of Japanese Patent Laid-Open No. 2002-226919 (Patent literature 1).

The high frequency induction heating apparatus as described in Japanese Patent Laid-Open No. 2002-226919 is configured as shown in FIG. 1 in the patent literature. However, FIG. 9 shows a high frequency induction heating apparatus 6 which is configured similarly to the apparatus as described in the patent literature, and which uses a semi-open saddle type high frequency induction heating coil 5.

As shown in FIG. 9, the high frequency induction heating apparatus 6 is configured by including: a pair of side plates 7 which are connected to the apparatus main body side, so as to be arranged to face each other; the semi-open saddle type high frequency induction heating coil 5 which is arranged in a lower end side opening portion of the side plate 7, so as to be supported by the side plate 7; and guide chips 8a, 8b and 8c for a high frequency induction heating coil which are arranged at predetermined positions (in the present example, three places of the upper side portion with respect to the center line of the journal portion 2 of the crankshaft 1 and of the left and right side portions with respect to the center line of the journal portion 2) corresponding to the semi-open saddle type high frequency induction heating coil 5, so as to be attached to the side plate 7, and the like. Also, the high frequency induction heating apparatus 6 is configured such that a power supply lead conductor 9 is connected to the semi-open saddle type high frequency induction heating coil 5, and such that cooling water supply means 10 for quickly cooling the journal portion 2 of the crankshaft 1, and the like, is provided. Note that the guide chips 8a, 8b and 8c for high frequency induction heating coil are members which are provided to secure a predetermined gap between the journal portion 2 of the crankshaft 1 and the semi-open saddle type high frequency induction heating coil 5 at the time when the journal portion 2 of the crankshaft 1 is subjected to high frequency induction heating by the semi-open saddle type high frequency induction heating coil 5, and are configured such that the semi-open saddle type high frequency induction heating coil 5 is mounted, via the guide chips 8a, 8b and 8c, on the journal portion 2 which is rotated about the axis line of the crankshaft 1 (the center line of the journal portion 2).

Patent literature 1: Japanese Patent Application Laid-Open No. 2002-226919

### DISCLOSURE OF INVENTION

### Technical Problem

As shown in FIG. 9, the three guide chips 8a, 8b and 8c for high frequency induction heating coil in the high frequency induction heating apparatus 6 are all fixed to the side plates 7, and are arranged in an immovable state in the radial direction and in the width direction of the journal portion 2.

In such fixed type guide chips 8a, 8b and 8c for high frequency induction heating coil, when, as shown in FIG. 10, the diameter D₁ of the journal portion 2 is smaller than the diameter D₂ of a common circle 12 passing through the respective distal end portions (vertexes) of the three guide chips 8a, 8b and 8c for high frequency induction heating coil (D₁<D₂), the journal portion 2 can be positioned within the region surrounded by the distal end portions of the guide chips 8a, 8b and 8c for a high frequency induction heating coil. However, in this case, when, as shown in FIG. 10, the journal portion 2 is brought into contact with the two guide chips 8a and 8b for high frequency induction heating coil among the three guide chip 8a, 8b and 8c for high frequency induction heating coil, a gap δ is generated between the remaining guide chip 8c for high frequency induction heating coil and the outer peripheral surface of the journal portion 2. Furthermore, in contrast, when the diameter D₁ of the journal portion 2 is larger than the diameter D₂ of the common circle 12 passing through the respective distal end portions of the three guide chips 8a, 8b and 8c for high frequency induction heating coil (D₁>D₂), the journal portion 2 cannot be positioned within the region of the common circle 12 surrounded by the distal end portions of the guide chips 8a, 8b and 8c for high frequency induction heating coil. Thus, the guide chips are usually set so as to satisfy the relationship D₁<D₂.

As described above, the gap δ exists between the journal portion 2 and the guide chip 8c for a high frequency induction heating coil. Thus, in many cases, the journal portion 2 is subjected to high frequency induction hardening in the state in which the journal portion 2 is not positioned at the center with respect to the guide chips 8a, 8b and 8c for a high frequency induction heating coil (the state in which the center of the journal portion 2 is not positioned at a predetermined central position). This results in a problem that the depth of a hardened case S formed in the outer peripheral surface of the journal portion 2 becomes uneven as shown in FIG. 11, and it is thereby not possible to perform precise hardening.

The present invention has been made in order to solve the above-described problem. An object of the present invention is to provide an arrangement structure for guide chips for high frequency induction heating coil, which structure is capable of correctly positioning the center of a journal portion or a pin portion of a crankshaft, and thereby capable of uniformily applying high frequency induction heating to the journal portion or the pin portion so as to make the hardened case uniform, and which structure is capable of performing the high frequency induction heating and hardening comparatively simply and inexpensively. Furthermore, an object of the present invention is to provide an arrangement structure of guide chips for a high frequency induction heating coil, which structure is capable of performing not only the positioning of the center of the journal portion or the pin portion, but also the positioning in the width direction of the journal portion or the pin portion.

### Solution to Problem

In order to achieve the above-described object, according to the present invention, there is provided an arrangement structure of three upper and left and right side guide chips for high frequency induction heating coil, which are respectively attached to a side plate for supporting a semi-open saddle type high frequency induction heating coil, and which are respectively arranged in contact with the upper side portion and the left and right side portions of a journal portion or a pin portion of a crankshaft in order to secure a predetermined gap (0.5 mm to 3.5 mm) between the journal portion or the pin portion and the semi-open saddle type high frequency induction heating coil at the time when the journal portion or the pin portion is subjected to high frequency induction heating by the semi-open saddle type high frequency induction heating coil, the arrangement structure being characterized in that the upper side guide chip for high frequency induction heating coil is attached to the side plate in a fixed state, in that at least one of the left and right side guide chips for high frequency induction heating coil is arranged so as to be movable along the radial direction of the journal portion or the pin portion, and in that in a free state in which the three guide chips for high frequency induction heating coil are not brought into contact with the journal portion or the pin portion, the dimension between the distal end portions of the left and right side guide chips for high frequency induction heating coil is set to become smaller than the outside diameter dimension of the journal portion or the pin portion.

Furthermore, in the present invention, it is configured such that the guide chip for high frequency induction heating coil, which is arranged so as to be movable, is configured to be elastically supported by the side plate in a cantilever state.

Furthermore, in the present invention, among the three guide chips for high frequency induction heating coil, at least the guide chip for high frequency induction heating coil, which is attached to the side plate in the fixed state, is configured such that the width dimension of the guide chip can be changed in the width direction of the journal portion or the pin portion, and such that the width dimension of the guide chip for high frequency induction heating coil, the width dimension of which can be changed, is set to become larger than the width dimension of the journal portion or the pin portion in a free state in which the guide chip for a high frequency induction heating coil, the width dimension of which can be changed, is not inserted and arranged between the mutually adjacent counterweight portions of the crankshaft

### Advantageous Effects of Invention

In the first aspect according to the present invention, the upper side guide chip for high frequency induction heating coil is attached to the side plate in the fixed state, and at least one of the left and right side guide chips for high frequency induction heating coil is arranged in the side plate so as to be movable along the radial direction of the journal portion or the pin portion so that the dimension between the distal end portions of the left and right side guide chips for high frequency induction heating coil is set to be smaller than the outside diameter dimension of the journal portion or the pin portion in the free state in which the three guide chips for high frequency induction heating coil are not brought into contact with the journal portion or the pin portion. Thus, at least one of the left and right side guide chips for high frequency induction heating coil is formed so as to be able to be moved (movable) in the radial direction of the journal portion or the pin portion, and hence the journal portion or the pin portion can be brought into contact with all three guide chips for high frequency induction heating coil. Thereby, the position of the fixed side guide chip for high frequency induction heating coil can be correctly set, so that the center of the journal portion or the pin portion can be correctly positioned. As a result, it is possible to uniformly apply high frequency induction heating to the outer peripheral surface of the journal portion or the pin portion, and hence it is possible to form a hardened case having a uniform thickness (depth) in the outer peripheral surface of the journal portion or the pin portion. Of course, it is possible to perform the positioning of the center of the journal portion or the pin portion even when the left and right side guide chips for high frequency induction heating coil are both configured to be movable (in a movable structure). Furthermore, even when the diameter of the journal portions or the pin portions, which are portions to be heated, is slightly varied (about ±1.5 mm), all the journal portions or the pin portions can be set in the region surrounded by the distal end portions of the three guide chips for high frequency induction heating coil.

Furthermore, in the second aspect according to the present invention, the guide chip for high frequency induction heating coil, which is movably arranged, is configured so as to be elastically supported in a cantilever state (cantilever spring supported) by the side plate, and hence, it is possible to arrange the guide chip for high frequency induction heating coil comparatively simply and compactly.

Furthermore, in the third aspect according to the present invention, among the three guide chips for high frequency induction heating coil, at least the guide chip for high frequency induction heating coil, which is attached to the side plate in the fixed state, is configured such that the width dimension of the guide chip can be changed in the width direction of the journal portion or the pin portion. Furthermore, the width dimension of the guide chip for high frequency induction heating coil, the width dimension of which can be changed, is set to be larger than the width dimension of the journal portion or the pin portion in the free state in which the guide chip for high frequency induction heating coil, the width dimension of which can be changed, is not inserted and arranged between the mutually adjacent counterweight portions of the crankshaft. Thus, in addition to the positioning of the center of the journal portion or the pin portion, which are portions to be heated, the positioning in the width direction of the journal portion or the pin portion can also be correctly performed, so that it is possible to form a desired stable hardened case as a whole.

### BRIEF DESCRIPTION OF DRAWINGS

FIG. 1 is a front view showing a main portion of a high frequency induction heating apparatus having an arrangement structure of guide chips for high frequency induction heating coil according to a first embodiment of the present invention;

FIG. 2 is a front view showing a side plate of the high frequency induction heating apparatus, to which plate the guide chips for high frequency induction heating coil are attached;

FIG. 3 shows the guide chip for high frequency induction heating coil according to the first embodiment of the present invention;

FIG. 3(a) is a perspective view of the guide chip for high frequency induction heating coil;

FIG. 3(b) is a sectional view taken along the A-A in FIG. 3(a);

FIG. 4 is an illustration showing a state in which the center of a journal portion is positioned by the guide chips for high frequency induction heating coil according to the first embodiment of the present invention;

FIG. 5 is a sectional view showing a hardened case which is formed in the outer peripheral surface of the journal portion in the case in which the journal portion is subjected to high frequency induction heating by using the guide chips for high frequency induction heating coil according to the first embodiment of the present invention, so as to be hardened;

FIG. 6 is a figure showing a structure of a (flexible) guide chip for high frequency induction heating coil, the width dimension of which can be changed;

FIG. 6(a) is a sectional view of the guide chip for high frequency induction heating coil;

FIG. 6(b) is a front view of the guide chip for high frequency induction heating coil;

FIG. 6(c) is a sectional view showing an engagement state with the journal portion in the case in which the guide chip for high frequency induction heating coil is used;

FIG. 7 is a figure showing a second embodiment, and is a front view showing a case in which the left and right side guide chips for high frequency induction heating coil are configured to be able to be moved (movable) similarly to FIG. 2;

FIG. 8 is a side view of a crankshaft;

FIG. 9 is a front view of a main portion of a high frequency induction heating apparatus having a conventional arrangement structure of guide chips for high frequency induction heating coil;

FIG. 10 is an illustration for explaining a problem at the time of high frequency induction heating in the case in which the conventional arrangement structure of the guide chips for high frequency induction heating coil is used; and

FIG. 11 is a sectional view showing a hardened case formed in the outer peripheral surface of a journal portion in the case in which the journal portion is subjected to high frequency induction heating by using the high frequency induction heating apparatus having the conventional arrangement structure of the guide chips for high frequency induction heating coil, so as to be hardened.

### REFERENCE SIGNS LIST

1 Crankshaft
2 Journal portion
3 Counterweight portion
4 Pin portion
5 Semi-open saddle type high frequency induction heating coil
7 Side plate
7a Side plate body
20 High frequency induction heating apparatus
21a, 21b, 21c Guide chip for high frequency induction heating coil
22 Guide chip main body
23 Flexible plate
33 Slit
37 Gap

### DESCRIPTION OF EMBODIMENTS

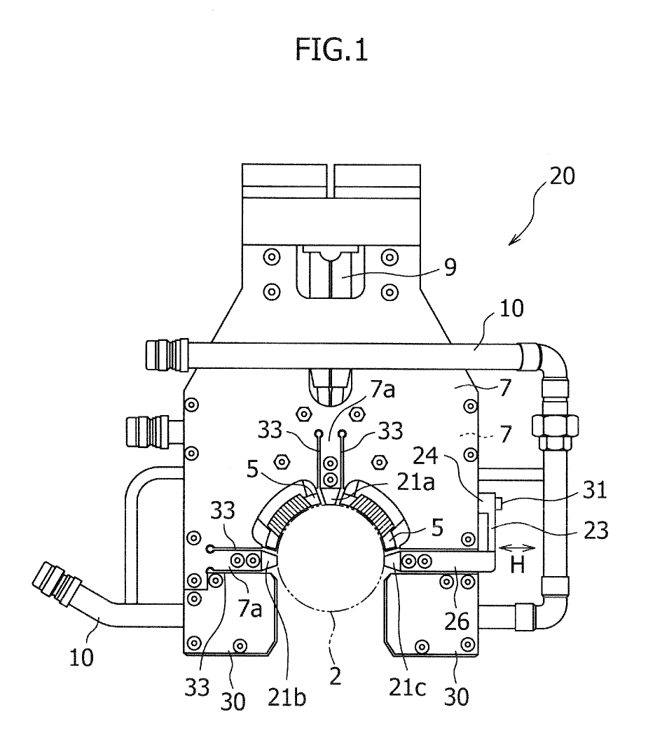

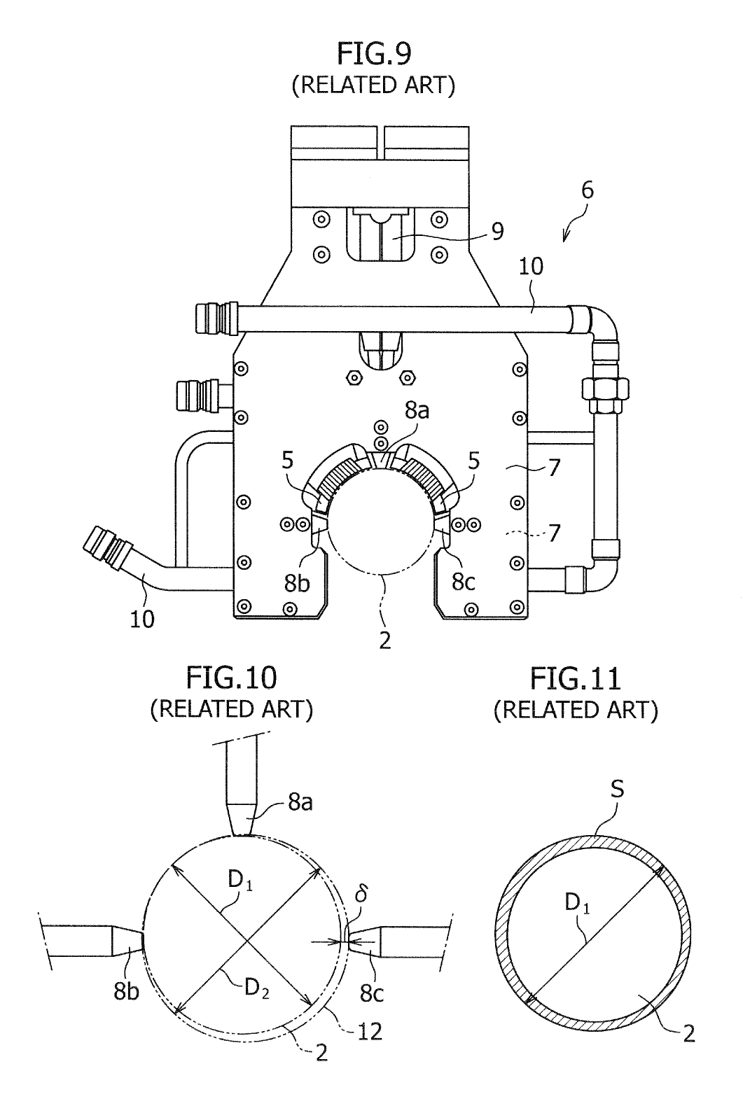

In the following, arrangement structures of guide chips for a high frequency induction heating coil according to embodiments of the present invention will be described with reference to FIG. 1 to FIG. 7. Note that in FIG. 1 to FIG. 7, portions which are the same as those shown in FIG. 8 to FIG. 11 are denoted by the same reference numerals and characters, and the explanation of the portions is omitted.

### EXAMPLE 1

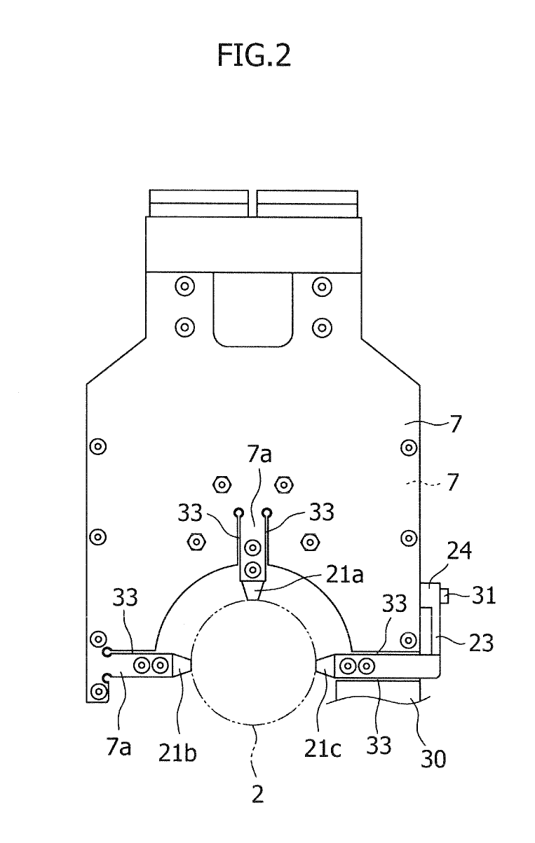

FIG. 1 shows a high frequency induction heating apparatus 20 having an arrangement structure of guide chips for a high frequency induction heating coil according to a first embodiment of the present invention. The high frequency induction heating apparatus 20 is used to apply high frequency induction heating to a journal portion 2 of a crankshaft 1. As shown in FIG. 1, the high frequency induction heating apparatus 20 includes a pair of side plates 7 which are respectively connected to the side of a transformer (not shown) and arranged to face each other, a semi-open saddle type high frequency induction heating coil 5 which is arranged in a lower end side opening portion of the side plates 7 so as to be supported by the side plates 7, a power supply lead conductor 9 which supplies high frequency power to the semi-open saddle type high frequency induction heating coil 5 from a power source (not shown), three guide chips 21a, 21b and 21c for high frequency induction heating coil which are attached at predetermined positions of the side plate 7 in correspondence with the semi-open saddle type high frequency induction heating coil 5, and the like. Furthermore, cooling water supply means 10 for spraying cooling water for hardening to the journal portion 2 subjected to high frequency induction heating by the semi-open saddle type high frequency induction heating coil 5 is additionally provided in the high frequency induction heating apparatus 20, so that a high frequency induction hardening apparatus is configured. Note that FIG. 2 is a front view of the side plate 7 for representing the structure of the three guide chips 21a, 21b and 21c for a high frequency induction heating coil which are main components of the present embodiment.

The three guide chips 21a, 21b and 21c for a high frequency induction heating coil, which are respectively attached to the side plates 7 for supporting the semi-open saddle type high frequency induction heating coil 5, are respectively arranged in contact with the upper side portion and the left and right side portions of the journal portion 2 of the crankshaft 1, which portion is driven and rotated about the center line of the journal portion 2 by a rotary drive mechanism (not shown), in order to secure a predetermined gap (0.5 mm to 3.5 mm) between the journal portion 2 and the semi-open saddle type high frequency induction heating coil 5 at the time when the journal portion 2 of the crankshaft 1 is subjected to high frequency induction heating by the semi-open saddle type high frequency induction heating coil 5. Specifically, as shown in FIG. 1 and FIG. 2, among the three guide chips 21a, 21b and 21c for high frequency induction heating coil, the one guide chip 21a is arranged at the upper side portion with respect to the center line of the journal portion 2 of the crankshaft 1, and the other two guide chips 21b and 21c for high frequency induction heating coil are arranged at the left and right side portions with respect to the center line of the journal portion 2.

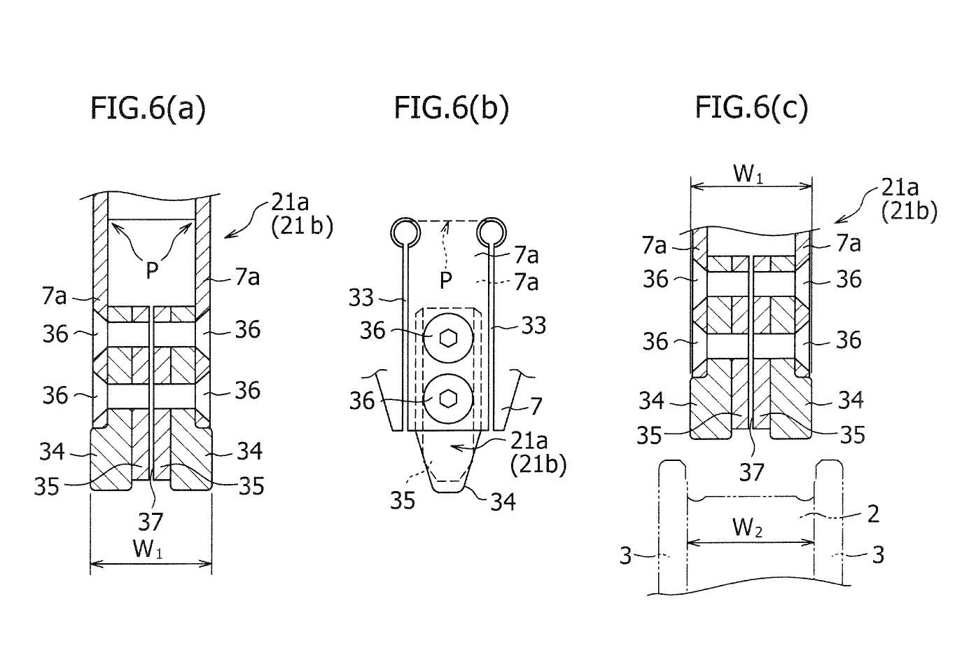

In the present embodiment, the guide chips 21a and 21b for high frequency induction heating coil on the upper side and the left side in FIG. 1 and FIG. 2 are attached to the side plate 7 in a fixed state in the radial direction of the journal portion 2, but are configured so that the width dimension thereof can be changed. Note that the width dimension of the guide chips 21a and 21b for high frequency induction heating coil may also be fixed depending on the structure and precision of the journal portion 2. On the other hand, the structure in which the width dimension can be changed will be described briefly below with reference to FIG. 6.

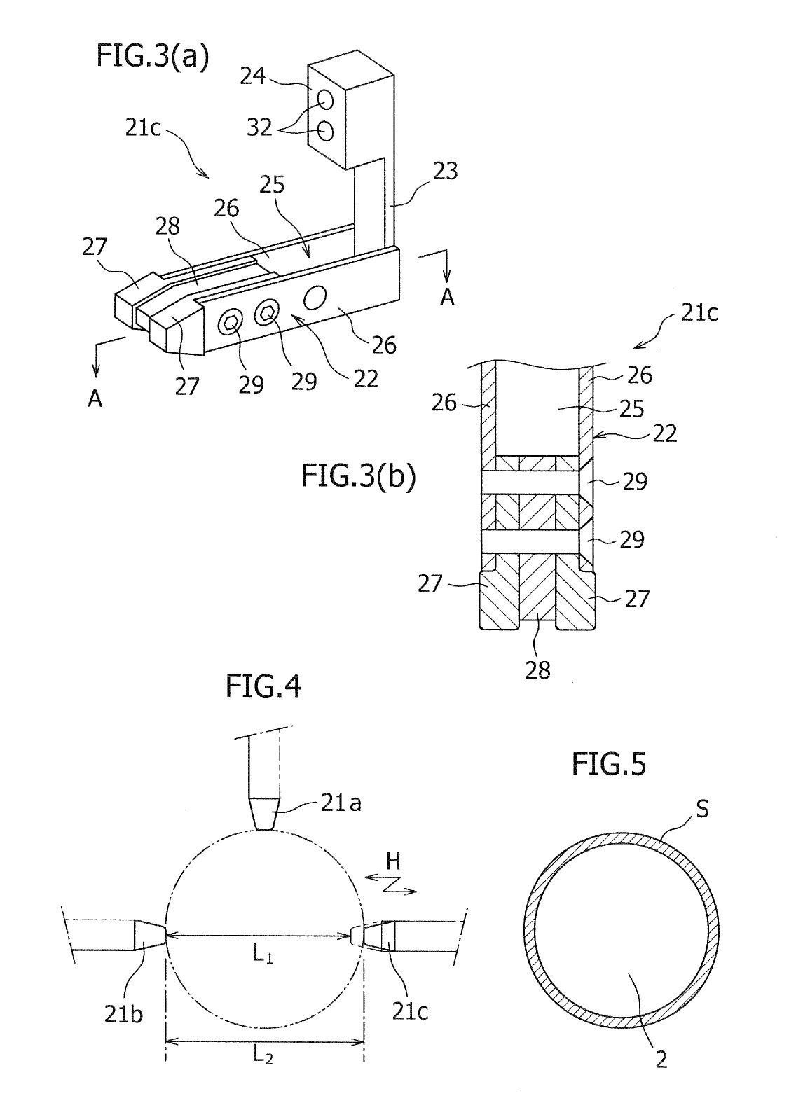

Furthermore, the guide chip other than the guide chips 21a and 21b for high frequency induction heating coil on the upper side and the left side, that is, the guide chip 21c for high frequency induction heating coil on the right side in FIG. 1 and FIG. 2 is attached to the side plate 7 in a state in which the guide chip can be moved (movable) with respect to the journal portion 2 along the radial direction of the journal portion 2. As shown in FIG. 3(a) and FIG. 3(b), the movable type guide chip 21c for high frequency induction heating coil includes a guide chip main body 22, a flexible plate 23 which has a spring function and which is integrally connected to the proximal end side of the guide chip main body 22, and an attaching portion 24 provided at the upper end side of the flexible plate 23. The guide chip main body 22 is configured by plate bodies 26 and 26 arranged in parallel with each other via a gap 25, chips 27 and 27 accommodated in the gap 25, a chip fixing plate 28, screws 29 and 29 for fixing these components, and the like. Furthermore, the plate bodies 26 and 26 are connected to the flexible plate 23 as shown in FIG. 3(a). As shown in FIG. 1 and FIG. 2, the guide chip main body 22 is arranged between the side plate 7 and an auxiliary side plate 30 arranged below the side plate 7, so as to be separated with a gap from each of the side plate 7 and the auxiliary side plate 30. Furthermore, the attaching portion 24 at the upper portion of the flexible plate 23 is attached with screws 31 to a stretch member (not shown) stretched between the pair of side plates 7. Note that in FIG. 3, reference numeral 32 denotes a screw portion insertion hole in which the screw portion of the screw 31 is inserted. With the above-described configuration, the guide chip 21c for high frequency induction heating coil, which is arranged so as to be movable, is elastically supported in a cantilever state (cantilever spring supported) by the side plate 7, so that the guide chip main body 22 can be moved in the radial direction by the elasticity of the flexible plate 23.

Note that as shown in FIG. 4, the dimension L₁ between the distal end portions of the left and right side guide chips 21b and 21c for high frequency induction heating coil is set to be smaller than the outside diameter dimension L₂ of the journal portion 2 (L₁<L₂) in the free state in which the three guide chips 21a, 21b and 21c for high frequency induction heating coil are not brought into contact with the journal portion 2, that is, in the free state in which the movable type guide chip 21c for high frequency induction heating coil is not moved.

On the other hand, as will be described below, among the three guide chips for high frequency induction heating coil, the fixed type guide chips 21a and 21b for high frequency induction heating coil, which are attached to the side plate 7 in the fixed state in which the guide chips cannot be moved in the radial direction of the journal portion 2, are configured so that the width dimension of the guide chips can be changed in the width direction of the journal portion 2. Furthermore, the width dimension W₁ of the guide chips 21a and 21b for high frequency induction heating coil, the width dimension of which can be changed, is set to become larger than width dimension W₂ of the journal portion 2 (W₁>W₂ as shown in FIG. 6(c)) in the free state in which the guide chips for high frequency induction heating coil, the width dimension of which can be changed, are not inserted between the mutually adjacent counterweight portions 3 and 3 of the crankshaft.

In this way, the guide chip main body 22 is displaced along the direction shown by arrow H in FIG. 1 and FIG. 4 by using the proximal end portion of the flexible plate 23 as a fulcrum. Therefore, the movable type guide chip 21c for high frequency induction heating coil is always brought into contact with the outer peripheral surface of the journal portion 2, so as to press the journal portion 2 to the side of the left side fixed type guide chip 21b for high frequency induction heating coil which faces the right side movable type guide chip 21c for high frequency induction heating coil. As a result, the journal portion 2 is brought into contact with all the three guide chips 21a, 21b and 21c for high frequency induction heating coil and held by the guide chips 21a, 21b and 21c for high frequency induction heating coil, so that the positioning of the center (center positioning) of the journal portion 2 is performed.

Next, there will be described an operation at the time when the journal portion 2 of the crankshaft 1 is subjected to high frequency induction heating by the high frequency induction heating apparatus 20, so as to be hardened. First, when the journal portion 2 is positioned in the state in which the outer peripheral surface of the journal portion 2 is brought into contact with the upper side guide chip 21a for high frequency induction heating coil and the left side guide chip 21b for high frequency induction heating coil among the three guide chips 21a, 21b and 21c for high frequency induction heating coil, the right side guide chip 21c for high frequency induction heating coil in the free state is brought into contact with the outer peripheral surface of the journal portion 2, because as described above, the dimension L₁ between the distal end portions of the left and right side guide chips 21b and 21c for high frequency induction heating coil is set to be smaller than the outside diameter dimension L₂ of the journal portion 2 at the time when the three guide chips 21a, 21b and 21c for high frequency induction heating coil are not brought into contact with the outer peripheral surface of the journal portion 2 (that is, in the state in which the journal portion 2 is not subjected to high frequency induction heating by the high frequency induction heating coil 5). The guide chip 21c for high frequency induction heating coil is elastically supported by the side plate 7 in the cantilever state so as to be elastically movable in the radial direction of the journal portion 2, and hence the guide chip 21c for high frequency induction heating coil is moved in the arrow H direction in FIG. 4 (that is, the direction in which the interval between both the left and right side guide chips 21b and 21c for high frequency induction heating coil is increased) by the elasticity of the flexible portion 23, so as to be brought into press contact with the outer peripheral surface of the journal portion 2. Thereby, all the three guide chips 21a, 21b and 21c for high frequency induction heating coil are brought into contact with the outer peripheral surface of the journal portion 2. Thereby, the center of the journal portion 2 can be positioned, and in this state, the journal portion 2 is uniformly subjected to high frequency induction heating by supplying power to the semi-open saddle type high frequency induction heating coil 5. Then, cooling water is sprayed from the cooling water supply means 10 to the journal portion 2, so that a hardened case S having a uniform thickness as shown in FIG. 5 is formed in the outer peripheral surface of the journal portion 2.

Next, the structure and operation of the upper side and left side guide chips 21a and 21b for high frequency induction heating coil, which are made movable in the width direction, will be described with reference to FIG. 6(a), FIG. 6(b) and FIG. 6(c). First, each of the guide chips 21a and 21b for high frequency induction heating coil includes a pair of mutually facing side plate bodies 7a and 7a (see FIG. 1. FIG. 2 and FIG. 6(b)) which are respectively provided to the mutually facing side plates 7 and 7 in a flexible (bendable and deformable) manner by each of the pairs of mutually parallel slits 33 and 33, which pairs are respectively formed in the side plates 7 and 7 so as to be connected to the coil insertion opening portion of the side plate 7, chips 34 and 34 which are respectively fixed in close contact with the inner surfaces of the side plate bodies 7a and 7a, and the distal end sides of which are expanded to project from the external surface of the side plate bodies 7a and 7a, chip fixing plates 35 and 35 which are respectively fixed in close contact with the inner surfaces of the chips 34 and 34, and the like. As shown in FIG. 6(a) and FIG. 6(c), the respective sets, each of which includes one of the side plate bodies 7a and 7a, one of the chips 34 and 34, and one of the chip fixing plates 35 and 35, are separately fixed by a pair of screws 36 and 36 in both the left and right side portions. Also, the guide chips 21a and 21b for high frequency induction heating coil are configured such that in the free state (the state in which the guide chips 21a and 21b for high frequency induction heating coil are not inserted between the mutually adjacent counterweight portions 3 and 3), a gap 37 is formed between the chip fixing plates 35 and 35 as clearly shown in FIG. 6(a). Therefore, the side plate bodies 7a and 7a are set in the flexible state (movable state) in the direction in which the gap 37 is reduced by using, as a movement fulcrum, the portion indicated by reference character P in FIG. 6(a) and FIG. 6(b).

Note that as shown in FIG. 6(c), for example, in the case in which the width dimension of the journal portion 2 to be subjected to high frequency induction heating (thus, to be hardened) is set as W₂, the width dimension W₁ of the guide chips 21a and 21b for high frequency induction heating coil in the free state is set as W₁>W₂ as described above. However, the guide chips 21a and 21b for high frequency induction heating coil are configured to be flexible in the width direction, and hence are fitted into the width W₂ of the journal portion 2, so that the guide chips 21a and 21b for high frequency induction heating coil are positioned in the width direction.

In the above description, the movable type guide chip 21c for high frequency induction heating coil is not configured to be flexible in the width direction, but it is also technically possible that the movable type guide chip 21c for high frequency induction heating coil is configured so as to be flexible (movable) in the width direction. However, the detailed description of such configuration is omitted here.

### EXAMPLE 2

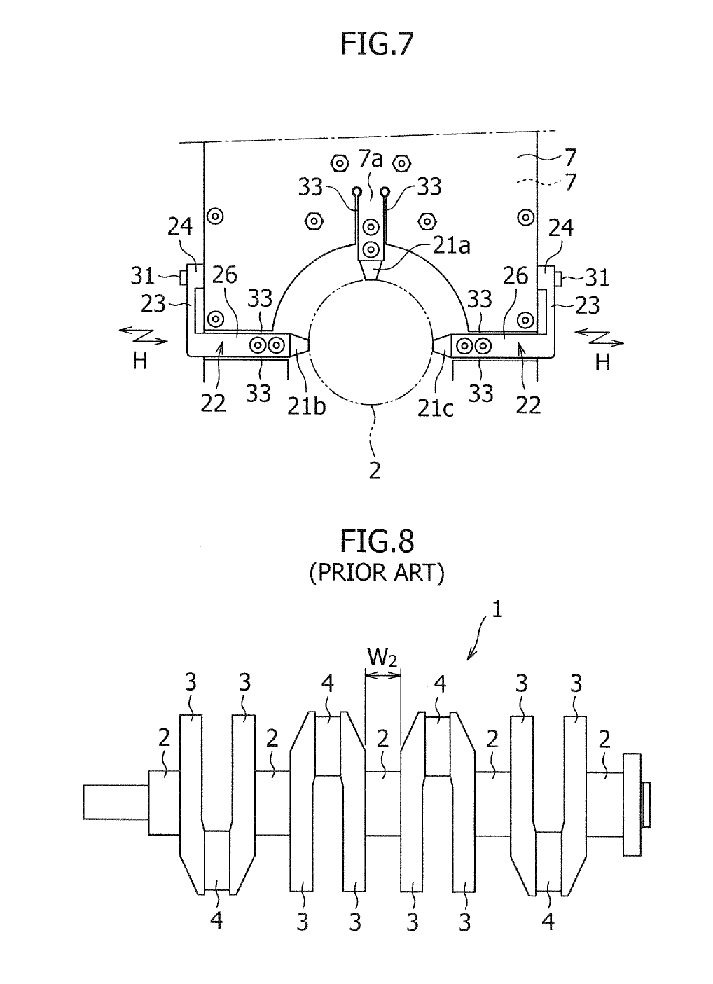

FIG. 7 shows a second embodiment according to the present invention. In the above-described first embodiment, the guide chips 21a and 21b for high frequency induction heating coil, which are made movable in the width direction of the journal portion 2, are arranged on the upper side and the left side of the journal portion 2, and the guide chip 21c, which is made movable in the radial direction of the journal portion 2, is arranged on the right side of the journal portion 2. However, in the second embodiment according to the present invention, as shown in FIG. 7, both the left and right side guide chips 21b and 21c for high frequency induction heating coil are configured as the movable type. In this case, the center of the journal portion 2 can be correctly positioned by uniformly setting the flexible state of the left and right side guide chips 21b and 21c for high frequency induction heating coil. Furthermore, even when the outer diameter of the journal portion 2 is varied, the center of the journal portion 2 can be surely positioned. As a result, the journal portion 2 is uniformly subjected to high frequency induction heating, so that a uniform hardened case S (see FIG. 5) can be formed.

In the above, the embodiments according to the present invention have been described. However, the present invention is not limited to the embodiments, and various modifications and changes can be made on the basis of the technical idea of the present invention. For example, the arrangement structure in which the guide chips 21b and 21c for high frequency induction heating coil are elastically movably arranged in the side plate 7, is not limited to the above-described embodiment, and various arrangement structures (mounting structures) may be adopted. Furthermore, in the above-described embodiments, there has been described the case in which the journal portion 2 of the crankshaft 1 is subjected to high frequency induction heating so as to be hardened. However, the present invention can also be applied to the case in which the pin portion 4 of the crankshaft 1 is subjected to high frequency induction heating so as to be hardened.

1. An arrangement structure of three upper and left and right side guide chips for a high frequency induction heating coil, which are respectively attached to a side plate for supporting a semi-open saddle type high frequency induction heating coil, and which are respectively arranged in contact with an upper side portion and left and right side portions of a journal portion or a pin portion of a crankshaft in order to secure a predetermined gap between the journal portion or the pin portion and the semi-open saddle type high frequency induction heating coil at the time when the journal portion or the pin portion is subjected to high frequency induction heating by the semi-open saddle type high frequency induction heating coil, the arrangement structure being characterized in that the upper side guide chip for high frequency induction heating coil is attached to the side plate in a fixed state, in that at least one of the left and right side guide chips for high frequency induction heating coil is arranged so as to be movable along the radial direction of the journal portion or the pin portion, and in that the dimension between the distal end portions of the left and right side guide chips for high frequency induction heating coil is set to become smaller than the outside diameter dimension of the journal portion or the pin portion in a free state in which the three guide chips for high frequency induction heating coil are not brought into contact with the journal portion or the pin portion.

2. An arrangement structure of the guide chips for high frequency induction heating coil, according to claim 1, characterized in that the guide chip for a high frequency induction heating coil, which is arranged to be movable, is configured to be elastically supported by the side plate in a cantilever state.

3. An arrangement structure of the guide chips for a high frequency induction heating coil, according to one of claim 1 and claim 2, characterized in that among the three guide chips for high frequency induction heating coil, at least the guide chip for a high frequency induction heating coil, which is attached to the side plate in the fixed state, is configured so that the width dimension of the guide chip can be changed in the width direction of the journal portion or the pin portion, and in that the width dimension of the guide chip for high frequency induction heating coil, the width dimension of which can be changed, is set to become larger than the width dimension of the journal portion or the pin portion in a free state in which the guide chip for high frequency induction heating coil, the width dimension of which can be changed, is not inserted and arranged between mutually adjacent counterweight portions of the crankshaft.
